(19) United States
(12) Patent Application Publication
(10) Pub. No.: US 2007/0094231 A1
(43) Pub. Date: Apr. 26, 2007

(54) Method of efficiently managing multimedia content and storage medium storing therein multimedia content using the same

(76) Inventor: Du-iI Kim, Gyeonggi-do (KR)

Correspondence Address: SUGHRUE MION, PLLC, 2100 PENNSYLVANIA AVENUE, N.W., SUITE 800, WASHINGTON, DC, 20037, US

(21) Appl. No.: 10/559,428

(22) PCT Filed: Apr. 22, 2004
(86) PCT No.: PCT/KR04/00920

§ 371 Date: Dec. 5, 2005

(30) Foreign Application Priority Data
Jun. 5, 2003 (KR) 10 2003 0036350

(51) Int. Cl. G06F 17/30

(52) U.S. Cl. 707/1

(57) ABSTRACT

Disclosed is a method of efficiently managing multimedia content and a storage medium using the same. A primary object of the present invention is to provide a method for arranging the multimedia content to efficiently manage multimedia content according to MPV standards and a method of improving the speed of search of multimedia content. To this end, a method of efficiently managing multimedia content according to the present invention comprises the steps of reading out a metadata file from a storage medium for the reproduction of specific multimedia content; when the multimedia content is reproduced using the read metadata file, reading out, from the metadata file, a path name and an actual address on the storage medium, which correspond to each of the multimedia content files; and directly accessing the relevant multimedia content file using information on the read path name and actual address. Therefore, there is an advantage in that the waste of storage space due to the storage of redundant master files can be prevented.

### TECHNICAL FIELD

The present invention relates to a method of efficiently managing multimedia content and a storage medium storing the multimedia content therein using the same. More particularly, the present invention relates to a method of efficiently managing multimedia content and a storage medium storing the multimedia content therein using the same, whereby multimedia content according to MultiPhotoVideo or MusicPhotoVideo specifications (hereinafter referred to as ‘MPV’) is recorded on a certain storage medium through a path name as a logical address value and a physical address value for the multimedia content in such a manner that the multimedia content can be arranged logically without being stored duplicately, thereby achieving efficient management thereof and enabling rapid access thereto.

### BACKGROUND ART

MPV is an industrial standard specification for multimedia titles, which was published on November 2002 by the Optical Storage Technology Association (OSTA; an association established by optical storage device manufacturers) and specifies how to arrange and describe content in disks so that multimedia content data, which are prepared using personal computers (PCs) and recorded on CDs or DVDs, can be easily accessed by means of electric home appliances such as CD players, DVD players and the like.

MVP is defined as at least one file described with metadata in an XML (eXtensible Markup Language) format, and allows content recorded on disks to be reproduced by a variety of devices such as CD or DVD players, according to the intentions of the producer of the content recorded on the disks (for example, involved in playback sequence, properties of content, description data, etc.).

Moreover, MPV allows the optimal content according to specifications or functions of respective reproducing devices to be retrieved and reproduced.

Basically, MPV is an independent solution, not subject to the types of data format of content, file system or storage medium. The types of data format include JPEG (Joint Photographic Experts Group Standard), MP3 (MPEG-1 Audio Layer-3), WMA (Windows Mulitimedia Audio), WMV (Windows Multimedia Video), MPEG (Moving Picture Experts Group)-1, MPEG-2, MPEG-4, AVI (Audio Video Interleave) and QuickTime MJPEG (Motion JPEG) the types of file systems include ISO9660-1 and Joliet, and the types of storage media include multi-session CDs, DVDs, memory cards and hard disks.

MPV standards provide a rendition function to reduce the time consumed in reading out multimedia data, which results from the inferior performances of embedded systems in a non-PC family to those in a PC family.

The rendition function serves to support the conversion of data of multimedia content from various sources into different formats (for example, involved in data format, resolution, color depth, etc.) whereby the content data can be reproduced regardless of the system conditions.

By way of example, a DVD ROM drive embedded in a DVD player (generally operating at 150 KB/sec, i.e. 1× CD ROM and ROM disk reading speed) will be considered. It takes 5 seconds (750/150=5 sec) to read an image (about 750 KB in size) taken by a 2 megapixel digital camera and it takes 20 seconds or more (3*1024/150=20.48 sec) to read an image (about 3 MB in size) taken by a 5 megapixel digital camera.

By use of the rendition function, a user can convert an image taken by a digital camera into an appropriate format (e.g., in view of data format, resolution, etc.) and then store the converted image in a separate file, so as to reproduce it later irrespective of the types of digital cameras.

Hereinafter, a resultant obtained by use of the rendition function, i.e. a converted multimedia content file, is defined as a rendition file.

In this regard, a rendition file resized adaptively to a television (hereinafter referred to as ‘TV’) resolution (640*480 in case of NTSC) is particularly referred to as a screen rendition (renditionusage:screen), and a rendition file resized adaptively to a thumbnail resolution (e.g., 160*120) is referred to as a thumbnail rendition (renditionusage:thumbnail).

Meanwhile, source multimedia content corresponding to an original is referred to as a master rendition (renditionusage:master) or master file.

FIGS. 1, 2 and 3 are schematic diagrams showing a layout and access processes according to a conventional method of managing multimedia content.

As shown in FIG. 1, if rendition files are to be created through renditionusage:screen and renditionusage:thumbnail by use of a predetermined master file, namely renditionusage:master (\textcircled{1}), a user performs the process of converting the format of the master file into JPG and resizing an image through the rendition function.

By using the master file (with resolution=very high (e.g., 2 mega pixels=1600*1200), data format=format of the original, data size=very big, and display time=very slow), the following respective rendition files will be created.

The renditionusage:screen has resolution=TV screen resolution (640*480 for NTSC), data format=JPG, data size=small (about 100 KB for NTSC), and display time=fast. The renditionusage:thumbnail has resolution=thumbnail resolution (160*120), data format=JPG, data size=very small (below 20 KB), and display time=very fast.

Once new rendition files have been created using a master file in such a manner, folders (hereinafter referred to as a ‘rendition folders’) for managing the created rendition files will be created as sub folders of a master folder. Specifically, sub folders named ‘screen’ and ‘thumbs’ will be created, as shown in FIG. 2.

In other words, master folders created by a user using predetermined multimedia content, i.e. album folders (‘Zoo trip-fancy stills,’ ‘Zoo trip-multimedia,’ and ‘Zoo trip-plain stills’), are created as sub folders of a root directory for a title (‘4,annotated-datasets-02Oct23’), and rendition folders (‘screen,’ ‘thumbs,’ and/or ‘music’) of the master folders are created as sub folders thereof.

According to such a layout for multimedia content, whenever a user creates master folders using predetermined multimedia content and rendition folders through the rendition function, a master file used for a rendition process is copied into the respective master folders.

Consequently, redundant master files exist in respective master folders, which leads to a problem in that a storage space of a CD fixed in storage capacity may be wasted.

In addition, a data CD is generally manufactured according to ISO9660 standards. When multimedia content is reproduced using metadata in XML format from a CD manufactured according to ISO9660 standards, it takes a great deal of time to retrieve and read the content from a LastURL (according to MPV standards; hereinafter referred to as ‘path name’) which is a logical address corresponding to the position on which a required file is recorded, whenever reproduction of multimedia data is requested.

Specifically, as shown in FIG. 3, if a specific image file is requested at a ‘current playback position,’ a player moves to a ‘path table’ area in which the layout for data recorded on the CD is stored (\textcircled{1}), searches for the path of a relevant folder having the requested image file and moves to the relevant folder (\textcircled{2}), and then retrieves the path of the requested image file in the relevant folder and moves to the position of the requested image file (\textcircled{3}). Thereafter, the player reads the relevant image file.

Therefore, there is needed a method of efficiently managing multimedia data so that the storage space of a CD can be utilized efficiently and data can be retrieved quickly even with low-speed optical devices.

### DISCLOSURE OF INVENTION

The primary object of the present invention is to provide a method for arranging multimedia content, which enables efficient management of multimedia content according to MPV standards.

Another object of the present invention is to facilitate access to multimedia content by adding content address information to XML metadata for reproduction of multimedia content.

According to present invention, a path name as a logical address corresponding to each of the multimedia content files and an actual address on a storage medium as a physical address corresponding to at least one of the multimedia content files are written in a metadata file in XML format to define how to reproduce the multimedia content files, in order to logically create a master folder, thereby preventing the waste of storage space of a CD due to storage of redundant master files and enabling quick access to relevant multimedia content through the actual address.

According to an aspect of the present invention, there is provided a storage medium, comprising a plurality of multimedia content files recorded thereon, and a metadata file in XML format recorded thereon, the metadata file defining how to reproduce the multimedia content files. The metadata file includes a path name as a logical address corresponding to each of the multimedia content files, and an actual address on the storage medium as a physical address corresponding to at least one of the multimedia content files.

According to another aspect of the present invention, there is provided a method of efficiently managing multimedia content, comprising the steps of reading out a metadata file from a storage medium for the reproduction of specific multimedia content; when the multimedia content is reproduced using the read metadata file, reading out, from the metadata file, a path name and an actual address on the storage medium, which correspond to each of the multimedia content files; and directly accessing the relevant multimedia content file using information on the read path name and actual address.

### BRIEF DESCRIPTION OF DRAWINGS

The above and other objects, features and advantages of the present invention will become apparent from the following description of preferred embodiments given in conjunction with the accompanying drawings, in which:

FIGS. 1, 2 and 3 are diagrams schematically showing a layout and an access process according to a conventional method of managing multimedia content;

FIG. 4 is a diagram schematically showing a logical layout of multimedia content files according to an embodiment of the present invention;

FIG. 5 shows source codes of XML metadata for file association between a master rendition and other renditions according to an embodiment of the present invention;

FIG. 6 is a block diagram schematically showing the configuration of a player according to an embodiment of the present invention;

FIG. 7 is a flowchart schematically illustrating the process of reading out multimedia content according to an embodiment of the present invention; and

FIG. 8 is a diagram schematically showing a path table according to an embodiment of the present invention.

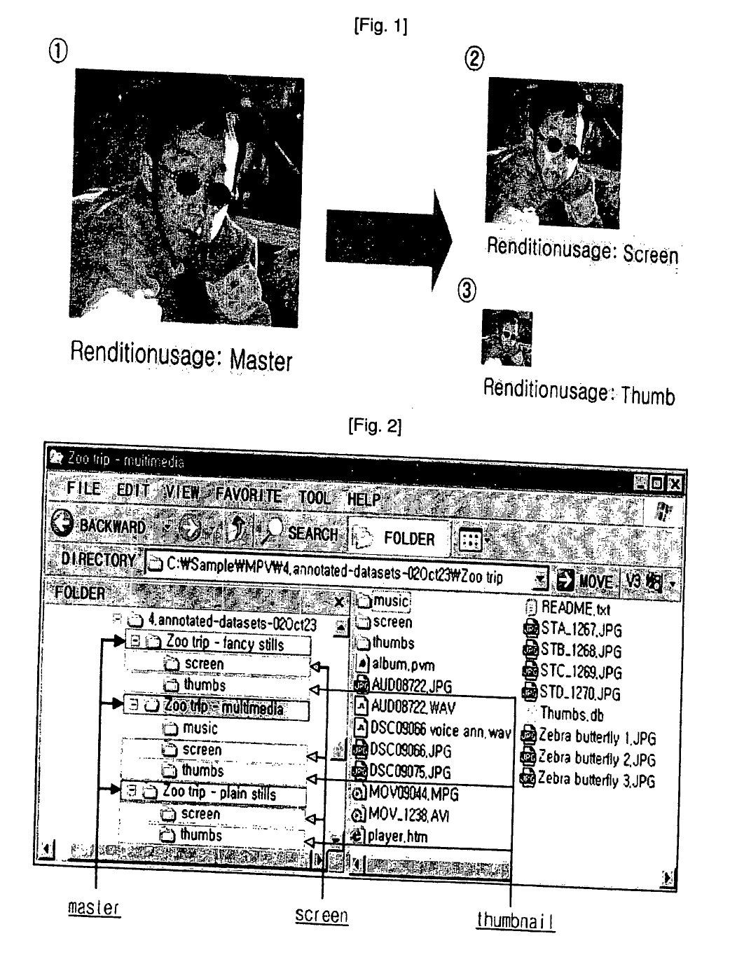

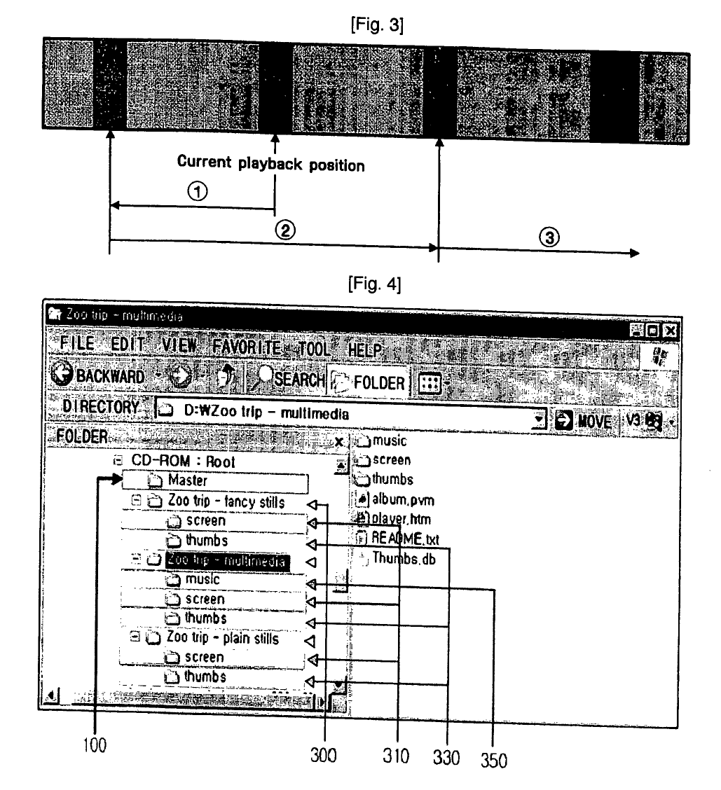

### BEST MODE FOR CARRYING OUT THE INVENTION

Hereinafter, a method of efficiently managing multimedia data and a storage medium storing therein the multimedia data using the same according to the present invention will be described in detail with reference to the accompanying drawings.

Although the method of efficiently managing multimedia data and storage medium storing therein the multimedia data using the same according to the present invention will be described below by way of example in connection with a method of managing images provided from an MPV album, it can be understood by those skilled in the art that various modifications and equivalents thereof can be made, for example, by a method of efficiently arranging and accessing multimedia content by providing a path name as a logical address corresponding to each multimedia content file and a real address on a storage medium as a physical address. Therefore, the scope of the present invention should be defined by the appended claims.

FIG. 4 is a diagram schematically showing a logical layout of multimedia content files according to an embodiment of the present invention.

As shown in FIG. 4, the file-arranging layout for the efficient management of multimedia content according to an embodiment of the present invention comprises a master folder 100 and a plurality of album folders 300.

The master folder 100 serves to manage master files for multimedia content to be reproduced from a CD, and thus, stores therein image, audio or video files of source multimedia content that is to be provided through the CD.

Each album folder 300 includes predetermined rendition folders, i.e. folders named ‘screen’ 310, ‘thumbs’ 320 and ‘music’ 330 for managing rendition files produced through a rendition process that uses a predetermined master file stored in the master folder 100.

When the master files are managed with the master folder 100 based on the afore-mentioned layout, a master file to be added is compared with existing master files to prevent the same master file from being redundantly stored.

To this end, the file name of the master file to be added is compared with those of the existing master files. If any existing master file with the same file name as the master file to be added is found, it is determined whether the two master files are of the same based on IDs assigned to respective multimedia content files according to OSTA standards.

If it is determined that the two IDs are not same, the file name of the master file to be added will be changed or the master file will be stored in a sub folder separately created. If the two IDs are same, the master file to be added will not be stored.

As the master files are managed with the master folder, XML metadata are required so that file association between the master files and other rendition files can be maintained.

FIG. 5 shows source codes of XML metadata for file association between a master rendition and other renditions according to an embodiment of the present invention.

As shown in FIG. 5, a path name (LastURL) for a master file of which the file name and ID are ‘DSC09075.JPG’ and ‘ID001100’ and which is managed with the master folder 100 is written as a path of the master folder as set forth below:

<mpv:LastURL mpv:filesystem=“Joliet”>../MASTER/DSC09075.JPG</mpv:LastURL>.

Further, paths of rendition files created using the master file (DSC09075.JPG) are input depending on respective renditions (renditionusage:thumbnail or renditionusage:screen) as follows:

screen:

<mpv:LastURL mpv:filesystem=“Joliet”>screen/DSC09075.JPG </mpv:LastURL>,

thumbnail:

<mpv:LastURL mpv:filesystem=“Joliet”>thumbs/DSC09075.JPG </mpv:LastURL>.

The XML codes associate the master file (DSC09075LJPG), which is managed with the master folder 100, with the rendition file (DSC09075.JPG) that is stored in the rendition folders (screen 310 and thumbs 330), thereby enabling normal playback of the master file through the respective rendition files modified according to a system environment.

Furthermore, during the process of reproducing multimedia content produced by an author using a master file managed with such a layout, address information on each master file is added to the XML metadata so that quick access to a master file required for the process of reproducing multimedia content can be gained.

The address information to be added to the XML metadata is actual addresses on the CD, i.e. physical addresses corresponding to the respective master files during the manufacture of the CD in which multimedia content constituting the album is recorded.

Each actual address on the CD comprises a start address (SectorStart) and an end address (SectorEnd).

That is, the following XML metadata are added as the actual addresses of the respective master files.

<mpv:SectorStart mpv:filesystem=“Joliet”>start address</mpv:SectorStart>

<mpv:SectorEnd mpv:filesystem=“Joliet”>end address</mpv:SectorEnd>

The start address and end address incorporated into the XML metadata are extracted during the process of writing paths, which are allocated to respective files to be recorded on the CD, in a path table (e.g., file allocation table (FAT/FAT32) or table of content (TOC)) while the CD is burned.

Alternatively, the actual addresses at which the respective master files are written are extracted based on image files for the respective files recorded on the CD while the CD is burned.

Now, a method of efficiently reproducing multimedia content according to the present invention will be described in connection with the process of allowing a predetermined player to access a CD as a recording medium produced by means of the aforementioned method of managing multimedia content.

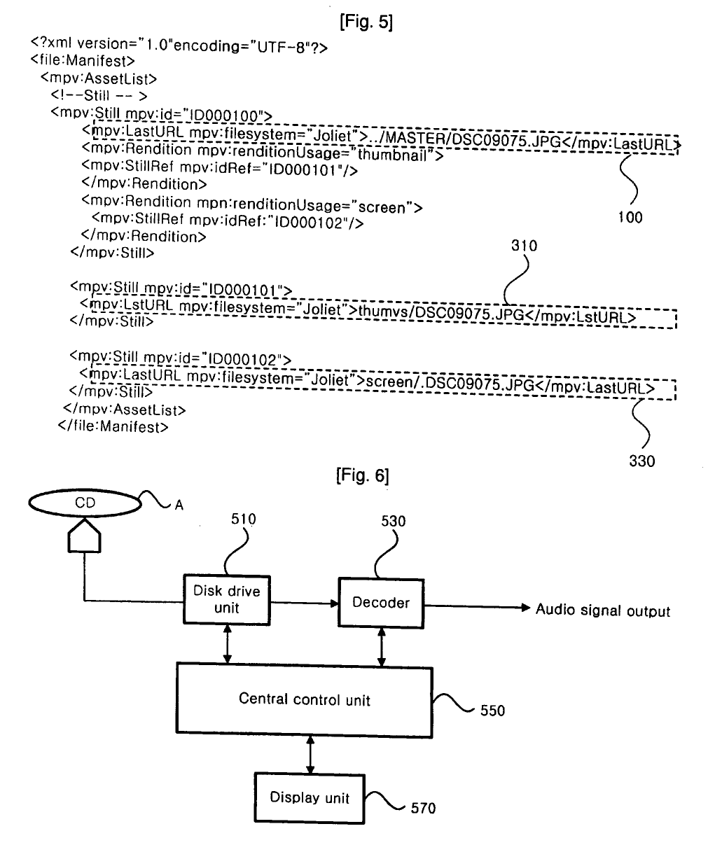

FIG. 6 is a block diagram schematically showing the configuration of a player according to an embodiment of the present invention.

As shown in FIG. 6, the player comprises a disk drive unit 510, a decoder 530, a central control unit 550, and a display unit 570.

First, if a user loads a CD A, data recorded on the CD A are picked up through focusing and tracking by the disk drive unit 510, and the picked-up data are input into the decoder 530.

The decoder 530 decodes the compressed data input from the disk drive unit 510, transfers an XML metadata file for the reproduction of multimedia content recorded on the CD A to the central control unit 550, and outputs audio, image and video signals as respective original signals.

Accordingly, the central control unit 550 properly reproduces the audio, image and video signals according to the XML metadata file.

If it is required to display a predetermined image file (i.e., master file) together with the current reproduction of the audio signal, the central control unit 550 outputs the decoded audio signal and directly reads out a relevant image file through the disk drive unit 510 by referring to address information on the relevant master file incorporated into the XML metadata.

Then, the read image file is displayed through the display unit 570.

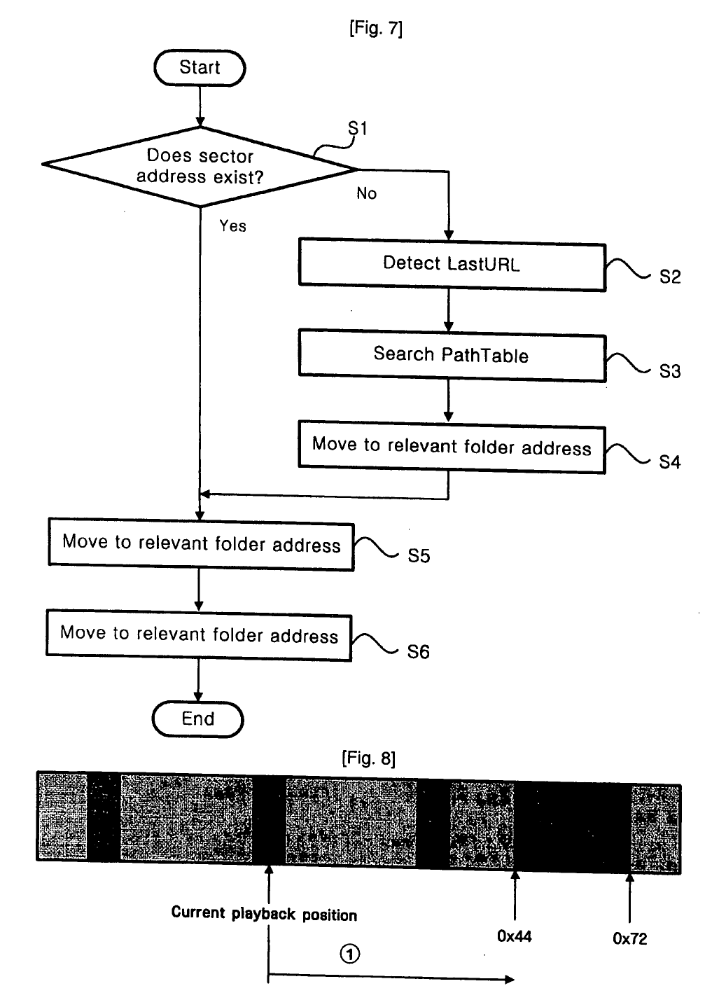

FIG. 7 is a flowchart schematically illustrating the process of reading out multimedia content according to an embodiment of the present invention.

As shown in FIG. 7, if a specific master file is requested during the process of reproducing multimedia content recorded on a CD by the player, the central control unit 550 of the player determines whether address information on the relevant master file exists in an XML metadata file (S1).

If it is determined that a sector address of the master file does not exist in the XML metadata, LastURL of the relevant master file is detected (S2) and the address of a folder having the relevant master file is searched for in a path table by using the detected LastURL (S3).

Then, access to the folder is gained using the searched folder address (S4), and address information on the relevant master file is detected (S5).

If it is determined that the address information on the master file exists in the XML metadata, the address information incorporated into the XML metadata is detected (S5).

If the address information on the required master file is detected through the afore-mentioned process, the central control unit 550 of the player causes the disk drive unit 510 to directly access and read out the relevant master file in the CD A using the detected address information (S6).

The process of reproducing the multimedia content according to the present invention performed as described above is now described in detail with reference to the accompanying drawings.

FIG. 8 is a diagram schematically showing a path table according to an embodiment of the present invention.

As an example, if the master file (DSC09075.JPG) is recorded between a start address of 0x44 and an end address of 0x72 as shown in FIG. 7, address information on the master file (DSC09075.JPG) is added to XML metadata as follows:

```
<?xml version=“1.0” encoding=“UTF-8”?>
<file:Manifest>
  <mpv:AssetList>
    <!--Still -->
    <mpv:Still mpv:id=“ID00100”>
    <mpv:LastURL mpv:filesystem=“Joliet”>
    ../MASTER/DSC09075.JPG</mpv:LastURL>
    <mpv:SectorStart mpv:filesystem=“Joliet”>0x44</mpv:SectorStart>
    <mpv:SectorEnd mpv:filesystem=“Joliet”>0x72</mpv:SectorEnd>
    <mpv:Rendition mpv:rendition usage=“thumbnail”>
        <mpv:StillRef mpv:idRef=“ID00101”/>
    </mpv:Rendition>
    <mpv:Rendition mpv:rendition usage=“screen”>
        <mpv:StillRef mpv:idRef=“ID00102”/>
    </mpv:Rendition>
...........
```

As the address information on the master file is incorporated into the XML metadata file, if the file ‘DSC09075.JPG’ is requested during the playback process, the player extracts the address information incorporated into the XML metadata file and accesses a relevant sector to read the file (\textcircled{1}).

Therefore, multimedia content recorded on an optical medium can be efficiently managed by separately managing master files through a master folder and incorporating address information on a master file into XML metadata for the reproduction of the multimedia content.

### INDUSTRIAL APPLICABILITY

According to the present invention, there is provided a method of efficiently arranging multimedia content to prevent the waste of storage space due to storage of redundant master files by providing a method of efficiently managing master files of multimedia content conforming to MPV standards through a master folder.

Further, the present invention is advantageous in that quick access to multimedia content can be gained by incorporating address information on master files into XML metadata.

The present invention has been described in detail in connection with the exemplary embodiment, but it will be apparent to those skilled in the art that various modifications or changes may be made thereto without departing from the spirit and scope of the invention as defined in the appended claims. Therefore, mere modifications to the present invention fall within the scope of the present invention.

1. A storage medium, comprising:
a plurality of multimedia content files recorded thereon, and
a metadata file in XML format recorded thereon, the metadata file defining how to reproduce the multimedia content files,
wherein the metadata file includes:
a path name as a logical address corresponding to each of the multimedia content files, and
an actual address on the storage medium as a physical address corresponding to at least one of the multimedia content files.

2. The storage medium as claimed in claim 1, wherein the metadata file further includes information on the type of file system used for the storage medium.

3. The storage medium as claimed in claim 1, wherein the logical address includes information on a master folder or rendition folders in which the multimedia content files are written logically.

4. The storage medium as claimed in claim 3, wherein the master folder is adapted to manage master files of the multimedia content files.

5. The storage medium as claimed in claim 3, wherein the rendition folders are adapted to manage rendition files of the multimedia content files.

6. A method of efficiently managing multimedia content, comprising the steps of:
reading out a metadata file from a storage medium for the reproduction of specific multimedia content;
reading out, from the metadata file, a path name and an actual address on the storage medium, which correspond to each of the multimedia content files, when the multimedia content is reproduced using the read metadata file; and
directly accessing the relevant multimedia content file using information on the read path name and actual address.

7. The method as claimed in claim 6, wherein the metadata file includes:
the path name as a logical address corresponding to each of the multimedia content files, and
the actual address on the storage medium as a physical address corresponding to at least one of the multimedia content files.

8. The method as claimed in claim 7, wherein the metadata file further includes information on the type of file system used for the storage medium.

9. The method as claimed in claim 7, wherein the logical address includes information on a master folder or rendition folders in which the multimedia content files are written logically.

10. The method as claimed in claim 9, wherein the master folder is adapted to manage master files of the multimedia content files.

11. The method as claimed in claim 9, wherein the rendition folders are adapted to manage rendition files of the multimedia content files.
